(19) United States
(12) Patent Application Publication
(10) Pub. No.: US 2018/0114058 A1
(43) Pub. Date: Apr. 26, 2018

(54) Drone piloted in a spherical coordinate system by a gestural with multi-segment members, control method and associated computer program

(71) Applicant: PARROT DRONES, Paris (FR)

(72) Inventor: Arthur Kahn, Paris (FR)

(21) Appl. No.: 15/792,150

(22) Filed: Oct. 24, 2017

(30) Foreign Application Priority Data
Oct. 25, 2016 (FR) 16 60341

(51) Int. Cl. G06K 9/00; G06F 3/01; G05D 1/00

(52) U.S. Cl. CPC G06K 9/00389; B64C 39/024; G05D 1/0016; G06F 3/017

(57) ABSTRACT

An electronic device for piloting a drone comprises an acquisition module to acquire a series of images of a scene including a user, taken by an image sensor equipping the drone, an electronic detection module for detecting, in the series of acquired images, a gesture by the user, and a control module for controlling a movement of the drone based on the detected gesture. The detection module is configured to detect a gesture with at least two separate limb segments of the user, and the electronic control module is configured to control the movement of the drone in a spherical coordinate system associated with the user, by calculating piloting instructions in the spherical coordinate system based on the detected gesture with several limb segments.

This application claims priority from French Patent Application No. 16 60341 filed on Oct. 25, 2016. The content of this application is incorporated herein by reference in its entirety.

### FIELD OF THE INVENTION

The present invention relates to an electronic device for piloting a drone. The electronic device comprises an acquisition module configured to acquire a series of images of a scene including a user, taken by an image sensor equipping the drone; an electronic detection module configured to detect, in the series of acquired images, a gesture by the user, the user having limbs, each limb including one or several segments; and an electronic control module configured to control the movement of the drone based on the detected gesture, the electronic control module being configured to calculate piloting instructions corresponding to said movement.

The invention also relates to a drone comprising an image sensor and such an electronic piloting device.

The invention also relates to a method for piloting the drone.

The invention also relates to a non-transitory computer-readable medium including a computer program including software instructions which, when executed by a computer, implement such a piloting method.

The invention relates to the field of drones, i.e., remotely-piloted flying motorized apparatuses. The invention in particular applies to rotary-wing drones, such as quadricopters, while also being applicable to other types of drones, for example fixed-wing drones.

### BACKGROUND OF THE INVENTION

A drone of the aforementioned type is known from document US 2015/0370250 A1. The drone is a rotary-wing drone, of the quadricopter type, able to be piloted using a portable electronic device, such as a smartphone or an electronic tablet. The drone is able to detect a gesture by the user, the gesture being made with the arm holding the portable electronic device, while pressing a button on the portable electronic device with a finger.

The drone is then able to perform a maneuver based on the detected gesture. A movement of the arm holding the portable electronic device from bottom to top drives the takeoff of the drone, and a sideways movement from left to right of said arm of the user drives the movement of the drone from left to right.

However, such a drone is sometimes complex to pilot, such piloting of the drone with a gesture made with the arm holding the portable electronic device not being very easy.

### SUMMARY OF THE INVENTION

The aim of the invention is then to propose an electronic piloting device that makes it easier for the user to pilot the drone, while not necessarily requiring the use of a joystick for piloting the drone.

To that end, the invention relates to an electronic piloting device of the aforementioned type, wherein the electronic detection module is configured to detect a gesture with at least two separate limb segments, and the electronic control module is configured to control the movement of the drone in a spherical coordinate system associated with the user, the piloting instructions being calculated in said spherical coordinate system based on the detected gesture with several limb segments.

With the electronic piloting device according to the invention, it then suffices to perform a gesture with two separate limb segments to cause a movement of the drone, without necessarily having to hold a portable electronic device in one hand, which also makes it possible to pilot the drone remotely.

The piloting of the drone using such a gesture according to the invention then offers piloting of the drone that is complementary to piloting via the portable electronic device, this complementary piloting being particularly useful when the user is not holding the portable electronic device in one hand, the portable electronic device then for example being stored in a pocket of a piece of clothing.

Furthermore, the movement(s) of the drone thus controlled are movements in a spherical coordinate system associated with the user, such as a variation in colatitude between the drone and the user, a variation in longitude between the drone and the user, or a variation in distance between the drone and the user, and these movements calculated in this spherical coordinate system are better adapted to piloting of the drone than movements in a Cartesian coordinate system. The spherical coordinate system in fact allows better tracking of the user during movements of the drone, the drone having its image sensor oriented toward the target. Such piloting is particularly well-suited during use of the drone in target tracking mode.

A Cartesian coordinate system a contrario implies an additional control relative to the spherical coordinate system for the rotation of the drone during the target tracking, in particular when the image sensor has a fixed orientation relative to the wing of the drone.

According to other advantageous aspects of the invention, the electronic piloting device comprises one or more of the following features, considered alone or according to all technically possible combinations:
the gesture detected to control the movement of the drone is a gesture with at least two segments of the two upper limbs of the user;
the spherical coordinate system used to calculate piloting instructions is the spherical coordinate system centered on the user;
the electronic control module is configured to command a variation in colatitude between the drone and the user, with substantially constant distance and longitude between the drone and the user, if a gesture is detected with variation of a vertical distance between the two segments, the vertical distance being defined along a vertical direction, parallel to an extension direction of the user in the standing position;
the electronic control module is configured to command a variation in longitude between the drone and the user, with substantially constant distance and colatitude between the drone and the user, if a gesture is detected with variation of a horizontal distance between the two segments, the horizontal distance being defined along a horizontal direction, perpendicular to an extension direction of the user in the standing position;
the electronic control module is configured to command a variation in distance between the drone and the user, with substantially constant colatitude and longitude between the drone and the user, if a gesture is detected with an angle variation between the two segments, the two segments forming a V;
a temporal drift of the variation commanded by the electronic control module depends on a movement speed of one segment relative to the other for the two segments generating the gesture, the electronic detection module being configured to measure said movement speed;
the electronic control module is configured to command landing of the drone, if a gesture is detected with rotation of the two segments relative to a horizontal direction, perpendicular to an extension direction of the user in the standing position, the two segments preferably forming a V;
the electronic control module is configured to command a movement of the drone in rotation around the user over a circle with a substantially constant colatitude, if a gesture is detected with oscillation of one of the two segments in the movement direction of the drone, the two segments forming a T, the rotation speed of the drone preferably depending on the oscillation speed of said limb relative to the other limb.

The invention also relates to a drone comprising an image sensor configured to take a series of images of a scene including a user and an electronic piloting device, in which the electronic piloting device is as defined above.

The invention also relates to a method for piloting a drone including an image sensor, piloting a drone including an image sensor, the method being carried out by an electronic device and comprising the acquisition of a series of images, taken by the sensor, of a scene including a user; the detection, in the series of acquired images, of a gesture by the user, the user having limbs, each limb including one or several segments; commanding a movement of the drone based on the detected gesture, via the calculation of piloting instructions corresponding to said movement, in which the detected gesture is a gesture with at least two separate limb segments, and the commanded movement is a movement of the drone in a spherical coordinate system associated with the user, the piloting instructions being calculated in said spherical coordinate system based on the detected gesture with several limb segments.

The invention also relates to a non-transitory computer-readable medium including a computer program including software instructions which, when executed by a computer, implement a method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of an electronic piloting device for piloting a drone via detection of a gesture by a user;

FIG. 2 is a schematic illustration of a colatitude variation of the drone of FIG. 1, if a first gesture by the user is detected;

FIG. 3 is a schematic illustration of a longitude variation of the drone of FIG. 1, if a second gesture by the user is detected;

FIG. 4 is a schematic illustration of a distance variation between the drone of FIG. 1 and the user, if a third gesture by the user is detected;

FIG. 5 is a schematic illustration of a landing of the drone of FIG. 1, if a fourth gesture by the user is detected; and

FIG. 6 is a flowchart of a piloting method according to the invention.

### DETAILED DESCRIPTION OF PREFERRED EMBODIMENTS

In the rest of the description, the expression “substantially constant” refers to identity to within plus or minus 10%, i.e., with a variation of no more than 10%, also preferably to identity to within plus or minus 5%, i.e., with a variation of no more than 5%.

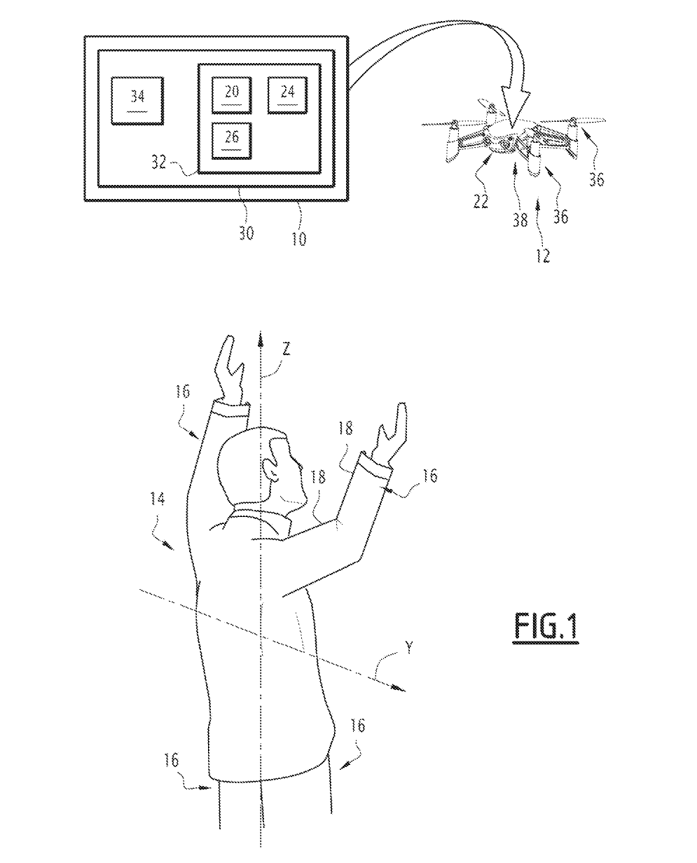

FIG. 1 shows an electronic device 10 for piloting a drone 12 via a gesture by a user 14 having several separate limbs 16, each limb 16 including one or several segments 18.

In the example of FIG. 1, the electronic piloting device 10 is on board the drone 12.

Alternatively, the electronic piloting device 10 is on board an electronic system, preferably portable, separate from the drone 12, the electronic system for example being a smartphone or an electronic tablet.

The electronic piloting device 10 comprises an acquisition module 20 configured to acquire a series of images of a scene including the user 14, taken by an image sensor 22 equipping the drone 12.

The electronic piloting device 10 further comprises an electronic detection module 24 configured to detect, in the series of acquired images, a gesture by the user 14, in particular a gesture with at least two segments 18 of separate limbs 16.

The electronic piloting device 10 further comprises an electronic control module 26 configured to command a movement of the drone 12 based on the detected gesture, the electronic control module 26 being configured to calculate piloting instructions corresponding to said movement, the movement being in a spherical coordinate system associated with the user 14 and the piloting instructions being calculated in said spherical coordinate system based on the detected gesture with several segments 18 of limbs 16.

In the example of FIG. 1, the electronic piloting device 10 comprises an information processing unit 30, for example made up of a memory 32 and a processor 34 associated with the memory 32.

The drone 12 is known in itself, and is a motorized flying vehicle able to be piloted remotely, in particular via a joystick, not shown.

The drone 12 is for example a rotary-wing drone, including at least one rotor 36. In FIG. 1, the drone includes a plurality of rotors 36, and is called multi-rotor drone. The number of rotors 36 is in particular equal to 4 in this example, and the drone 12 is then a quadrirotor drone. In an alternative that is not shown, the drone 12 is a fixed-wing drone.

The drone 12 includes a transmission module 38 configured to exchange data, preferably by radio waves, with one or several pieces of electronic equipment, in particular with the joystick, or even with other electronic elements, for example to transmit the image(s) acquired by the image sensor 22.

The user 14 is for example the pilot of the drone 10, the electronic piloting device 10 being particularly useful when the drone 12 is in a tracking mode to track the user 14, in particular when the pilot of the drone 12 is engaged in an athletic activity. The electronic piloting device 10 is also useful when the drone 12 is in a mode pointing toward the user, allowing the drone 12 still to aim for the user 14, allowing the user 14 the possibility of changing the relative position of the drone 12, for example by rotating around himself.

The user 14 preferably has two upper limbs 16 and two lower limbs 16, each limb 16 including one or several segments 18. The segments 18 of the upper limbs 16 are for example the arm, the forearm and the hand. The segments 18 of the lower limbs 16 are for example the thigh, the leg and the foot. For piloting of the drone 12, the limbs 16 that are preferably used to perform the gesture(s) intended to be detected for controlling the movement of the drone 12 are the upper limbs 16 of the user.

The joystick is known in itself, and makes it possible to pilot the drone 12. The joystick is optional within the meaning of the invention, the electronic piloting device 10 allowing precise piloting of the drone 12 via a detection of gesture(s) by the user 14, without requiring, at least at that moment, the use of the joystick, the joystick for example being stored in a pocket of a piece of clothing of the user 14.

The joystick is for example implemented by a smartphone or electronic tablet. Alternatively, the joystick comprises two gripping handles, each being intended to be grasped by a respective hand of the pilot, a plurality of control members, including two joysticks, each being arranged near a respective gripping handle and being intended to be actuated by the pilot, preferably by a respective thumb.

The joystick comprises a radio antenna and a radio transceiver, not shown, for exchanging data by radio waves with the drone 12, both uplink and downlink.

In the example of FIG. 1, the acquisition module 20, the detection module 24 and the control module 26, are each made in the form of software executable by the processor 34. The memory 32 of the information processing unit 30 is then suitable for storing acquisition software configured to acquire a series of images of a scene including the user 14, taken by the image sensor 22, detection software configured to detect, in the series of acquired images, a gesture by the user 14, with at least two separate segments 18 of limbs 16, and control software configured to control a movement of the drone 12 based on the detected gesture, in a spherical coordinate system associated with the user 14, the piloting instructions being calculated and said spherical coordinate system based on the detected gesture with several segments 18 of limbs 16. The processor 34 of the information processing unit 30 is then able to execute the acquisition software, the detection software and the control software.

In an alternative that is not shown, the acquisition module 20, the detection module 24 and the control module 26, are each made in the form of a programmable logic component, such as an FPGA (Field Programmable Gate Array), or in the form of a dedicated integrated circuit, such as an ASIC (Applications Specific Integrated Circuit).

The image sensor 22 is for example a front-viewing camera making it possible to obtain an image of the scene toward which the drone 12 is oriented. Alternatively, the image sensor 22 is a vertical-viewing camera, not shown, pointing downward and configured to capture successive images of terrain flown over by the drone 12.

The detection module 24 is configured to detect each gesture made by the user 14 via one or several image processing algorithms known in themselves. The detection module 24 is for example configured to detect the gesture, track the gesture and recognize the gesture. The detection is for example done via a segmentation algorithm configured to segment the gesture in the images relative to the background of the image, for example by color model, shape model and/or movement model. The tracking is for example done by particular filter, or by any other propagation method. The recognition is for example done by using a Hidden Markov model (HMM) or a linear or nonlinear classifier, for example a K-means positioning algorithm, a Support Vector Machine (SVM), a neural network or other means. The gesture detected to control the movement of the drone 12 is preferably a gesture with at least two segments 18 of the two upper limbs 16 of the user 14.

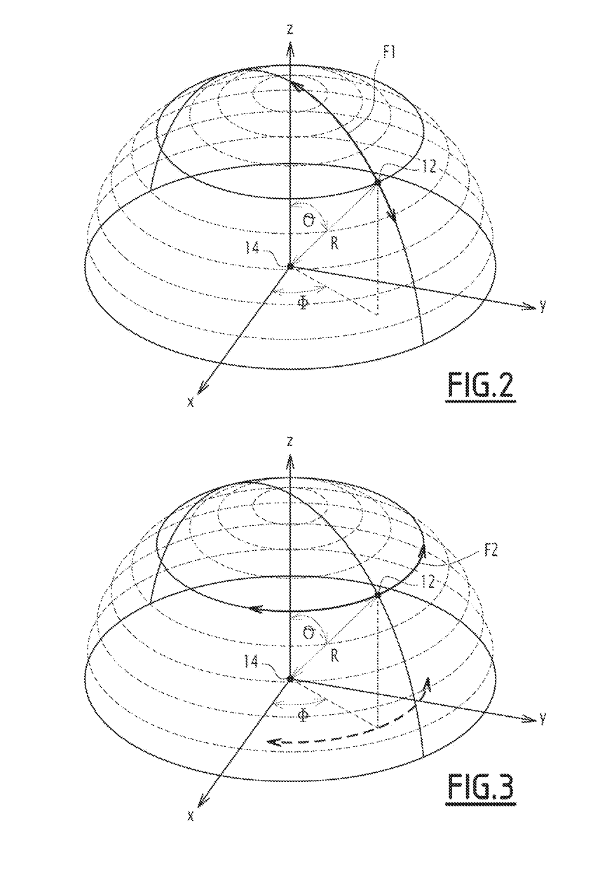

The control module 26 is then configured to command a movement of the drone 12 based on the detected gesture, by calculating piloting instructions corresponding to said movement, the movement being calculated in a spherical coordinate system associated with the user 14, preferably in the spherical coordinate system centered on the user 14 as shown in FIGS. 2 to 5, the piloting instructions then being calculated in said spherical coordinate system based on the detected gesture.

The control module 26 is preferably configured to send the piloting instructions thus calculated to an autopilot of the drone 12, to carry out the commanded movement.

The control module 26 is, for example, configured to command a variation of the colatitude θ between the drone 12 and the user 14, with distance R and longitude P between the drone 12 and the user 14, as shown by arrow F1 in FIG. 2, if a first gesture is detected with variation of a vertical distance between the two segments 18. The vertical distance is defined along a vertical direction Z, shown in FIG. 1, parallel to an extension direction of the user 14 in the standing position. The first gesture is preferably a gesture with both hands flat one above the other, for which the vertical distance between the hands increases or decreases. Alternatively, the first gesture is a gesture with the forearms.

For the first gesture, an increase in the vertical distance between the two segments 18 is for example associated with an increase in the altitude of the drone 12, i.e., associated with a decrease in its colatitude θ, and conversely a decrease in the vertical distance between the two segments 18 is associated with a decrease in the altitude of the drone 12, i.e., associated with an increase in its colatitude θ.

As an optional addition, the variation of the colatitude θ is commanded by variation increment(s), each segment movement 18 making it possible to control at most a maximal colatitude variation Δθₘₐₓ, where said maximum variation Δθₘₐₓ is for example predefined.

Additionally or alternatively, the control module 26 is configured to command a variation of the longitude ϕ between the drone 12 and the user 14, with distance R and colatitude θ between the drone 12 and the user 14, as shown by arrow F2 in FIG. 3, if a second gesture is detected with variation of a horizontal distance between the two segments 18. The horizontal distance is defined along a horizontal direction Y, shown in FIG. 1, perpendicular to the extension direction of the user 14 in the standing position. The second gesture is preferably a gesture with both hands next to one another, for which the horizontal distance between the hands increases or decreases, one hand preferably being immobile while the other is moved. Alternatively, the second gesture is a gesture with the forearms.

For the second gesture, a movement of the right hand to the right while keeping the left hand immobile is for example associated with a movement of the drone 12 to the right, and conversely, a movement of the left hand to the left while keeping the right hand immobile is associated with a movement of the drone 12 to the left.

As an optional addition, the variation of the longitude ϕ is commanded by variation increment(s), each segment movement 18 making it possible to control at most a maximal longitude variation Δϕₘₐₓ, where said maximum variation Δϕₘₐₓ is for example predefined.

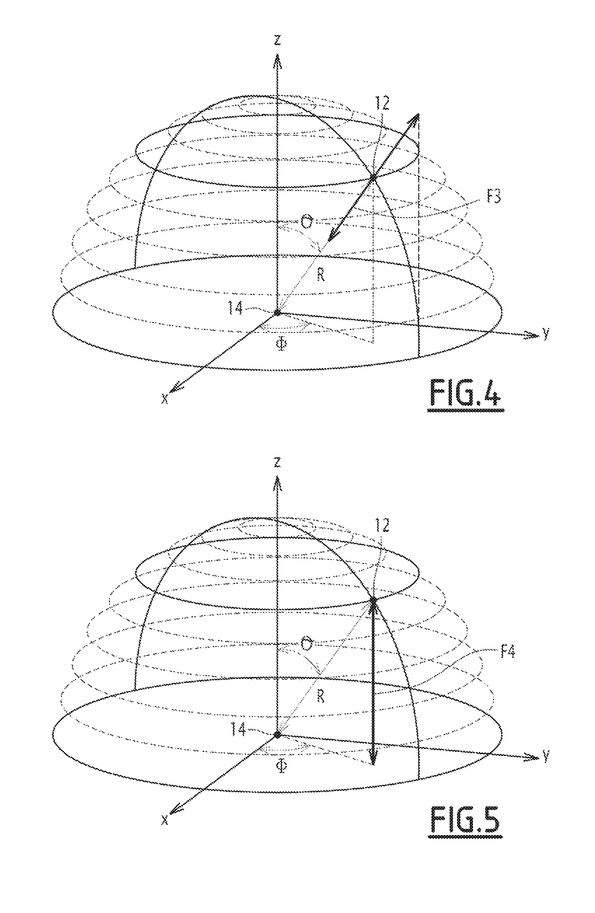

Additionally or alternatively, the control module 26 is configured to command a variation of the distance R between the drone 12 and the user 14, with colatitude θ and longitude ϕ between the drone 12 and the user 14, as shown by arrow F3 in FIG. 4, if a third gesture is detected with angle variation between the two segments 18, the two segments 18 forming a V. The third gesture is preferably a gesture with both arms in the air in the form of a V, for which the deviation between the arms increases or decreases. Alternatively, the third gesture is a gesture with the forearms.

For the third gesture, an increase in the deviation, i.e., an increase in the angle, between the two segments 18 is for example associated with an increase in the distance R between the drone 12 and the user 14, and conversely, a decrease in the deviation, i.e., a decrease in the angle, between the two segments 18 is associated with a decrease of said distance R.

As an optional addition, the variation of the distance R is commanded by variation increment(s), each segment movement 18 making it possible to control at most a maximal distance variation ΔRₘₐₓ, where said maximum variation ΔRₘₐₓ is for example predefined.

A temporal drift of the variation commanded by the electronic control module 26 depends on a movement speed of one segment 18 relative to the other for the two segments 18 generating the gesture, whether it for example involves the first gesture, the second gesture and/or the third gesture, the electronic detection module 24 being configured to measure said movement speed.

Additionally or alternatively, the control module 26 is configured to command landing of the drone 12, as shown by arrow F4 in FIG. 5, if a fourth gesture is detected with rotation of the two segments 18 relative to a horizontal direction Y, perpendicular to an extension direction of the user 14 in the standing position, the two segments 18 preferably forming a V. The fourth gesture is preferably a gesture with both arms in the form of a V, for which the rotation corresponds to a lowering of the arms toward the front. Alternatively, the fourth gesture is a gesture with the forearms.

As an optional addition, the control module 26 is configured, if the fourth gesture is detected, first to command lowering of the drone 12 to a predefined altitude relative to the ground, for example one meter from the ground, then secondly to command landing of the drone 14 only if confirmation from the user 14 is detected. The confirmation is for example done by a predefined action on the joystick, or by an additional predefined gesture, this additional gesture then being separate from the fourth gesture.

Additionally or alternatively, the control module 26 is configured to command a movement of the drone 12 in rotation around the user 14 over a circle with a substantially constant colatitude θ, if a fifth gesture is detected with oscillation of one of the two segments 18 in the movement direction of the drone 12, the two segments 18 forming a T.

The rotation speed of the drone 12 preferably depends on the oscillation speed of said limb 18 relative to the other limb 18.

The fifth gesture is preferably a gesture with both arms in the form of a T, with one arm immobile and the other arm oscillating in the direction in which the drone 12 must perform its rotational movement, also called orbital movement. Alternatively, the fifth gesture is a gesture with the forearms.

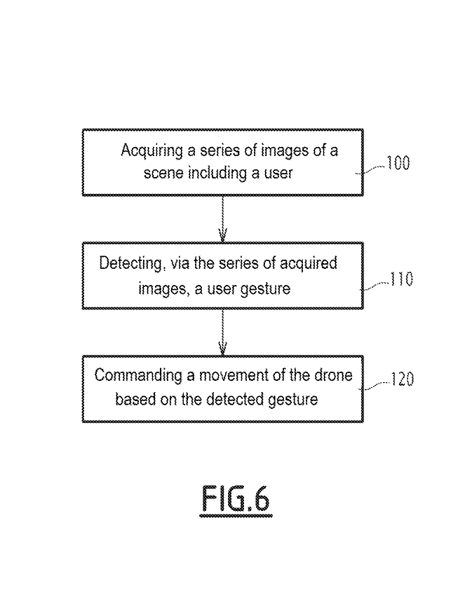

The operation of the drone 12 according to the invention, in particular the electronic piloting device 10, will now be described using FIG. 6, illustrating a flowchart of the piloting method according to the invention, implemented by computer.

During a step 100, the acquisition module 20 acquires a series of images of the scene including the user 14, the images having previously been taken by the image sensor 22.

The detection module 24 next detects, during step 110 and in the series of acquired images, a gesture done by the user 14, when the gesture is a gesture with at least two segments 18 of separate limbs 16, such as a gesture from among the first, second, third, fourth and fifth gestures previously described.

The control module 26 then commands, during step 120, the movement of the drone 12 in the spherical coordinate system associated with the user 14, preferably in the spherical coordinate system centered on the user 14, based on the gesture detected during the previous step 110, the piloting instructions then being calculated in said spherical coordinate system based on this gesture. For the actual implementation of the movement of the drone 12, the control module 26 for example sends the calculated piloting instructions to the autopilot of the drone 12.

The electronic piloting device 10 and the piloting method according to the invention then allow the user 14 to command certain maneuvers of the drone 12 in a similar manner, in particular without using a joystick, these maneuvers in fact being controlled via predefined gestures by the user 14.

These predefined gestures are gestures with two segments 18 of separate limbs 16 so as to be more easily detectable by the detection module 24.

The commanded movements are calculated in the spherical coordinate system, which allows better tracking of the user during movements of the drone 12, the drone 12 having its image sensor 22 oriented toward the user 14. Such piloting is particularly well-suited during use of the drone 12 in target tracking mode.

The piloting of the drone 12 using such gesture(s) according to the invention then offers piloting of the drone 12 that is complementary to piloting via the joystick, this complementary piloting being particularly useful when the user is not holding the joystick in one hand, the joystick then for example being stored in a pocket of a piece of clothing.

One can then see that the electronic piloting device 10 and the piloting method according to the invention make it possible to facilitate the piloting of the drone 12, while then not requiring the use of a joystick for piloting the drone 12 in this case.

1. An electronic device for piloting a drone, the device comprising:
an acquisition module configured to acquire a series of images of a scene including a user, taken by an image sensor equipping the drone,
an electronic detection module configured to detect, in the series of acquired images, a gesture by the user, the user having limbs, each limb including one or several segments,
an electronic control module configured to command a movement of the drone based on the detected gesture, the electronic control module being configured to calculate piloting instructions corresponding to said movement,
wherein the electronic detection module is configured to detect a gesture with at least two separate limb segments, and the electronic control module is configured to control the movement of the drone in a spherical coordinate system associated with the user, the piloting instructions being calculated in said spherical coordinate system based on the detected gesture with several limb segments.

2. The electronic device according to claim 1, wherein the gesture detected to control the movement of the drone is a gesture with at least two segments of the two upper limbs of the user.

3. The electronic device according to claim 1, wherein the spherical coordinate system used to calculate piloting instructions is the spherical coordinate system centered on the user.

4. The electronic device according to claim 1, wherein the electronic control module is configured to command a variation in colatitude between the drone and the user, with substantially constant distance and longitude between the drone and the user, if a gesture is detected with variation of a vertical distance between the two segments, the vertical distance being defined along a vertical direction, parallel to an extension direction of the user in the standing position.

5. The electronic device according to claim 1, wherein the electronic control module is configured to command a variation in longitude between the drone and the user, with substantially constant distance and colatitude between the drone and the user, if a gesture is detected with variation of a horizontal distance between the two segments, the horizontal distance being defined along a horizontal direction, perpendicular to an extension direction of the user in the standing position.

6. The electronic device according to claim 1, wherein the electronic control module is configured to command a variation in distance between the drone and the user, with substantially constant colatitude and longitude between the drone and the user, if a gesture is detected with an angle variation between the two segments, the two segments forming a V.

7. The electronic device according to claim 4, wherein a temporal drift of the variation commanded by the electronic control module depends on a movement speed of one segment relative to the other for the two segments generating the gesture, the electronic detection module being configured to measure said movement speed.

8. The electronic device according to claim 1, wherein the electronic control module is configured to command landing of the drone, if a gesture is detected with rotation of the two segments relative to a horizontal direction, perpendicular to an extension direction of the user in the standing position.

9. The electronic device according to claim 8, wherein the two segments form a V.

10. The electronic device according to claim 1, wherein the electronic control module is configured to command a movement of the drone in rotation around the user over a circle with a substantially constant colatitude, if a gesture is detected with oscillation of one of the two segments in the movement direction of the drone, the two segments forming a T.

11. The electronic device according to claim 10, wherein the rotation speed of the drone depends on the oscillation speed of said limb relative to the other limb.

12. A drone comprising an image sensor configured to take a series of images of a scene including a user and an electronic piloting device,
wherein the electronic piloting device is according to claim 1.

13. A method for piloting a drone including an image sensor, the method being carried out by an electronic device and including:
acquiring a series of images, taken by the sensor, of a scene including the user,
detecting, in the series of acquired images, a gesture by the user, the user having limbs, each limb including one or several segments,
commanding a movement of the drone based on the detected gesture, via the calculation of piloting instructions corresponding to said movement,
wherein the detected gesture is a gesture with at least two separate limb segments, and the commanded movement is a movement of the drone in a spherical coordinate system associated with the user, the piloting instructions being calculated in said spherical coordinate system based on the detected gesture with several limb segments.

14. A non-transitory computer-readable medium including a computer program comprising software instructions which, when executed by a computer, carry out a method according to claim 13.
